(19) United States
(12) Patent Application Publication
(10) Pub. No.: US 2014/0225416 A1
(43) Pub. Date: Aug. 14, 2014

(54) SORTING IN A MINING OPERATION

(71) Applicants: Damien Harding, Clifton Hill (AU); Claus Stoiber, South Jordan, UT (US)

(72) Inventors: Damien Harding, Clifton Hill (AU); Claus Stoiber, South Jordan, UT (US)

(73) Assignee: TECHNOLOGICAL RESOURCES PTY. LIMITED, Brisbane, QLD (AU)

(21) Appl. No.: 14/130,121

(22) PCT Filed: Jul. 9, 2012
(86) PCT No.: PCT/AU2012/000815

§ 371 Date: Apr. 4, 2014

Related U.S. Application Data
(60) Provisional application No. 61/505,620, filed on Jul. 8, 2011.

(51) Int. Cl. E21C 41/26; B07B 13/00

(52) U.S. Cl. CPC E21C 41/26; B07B 13/00
USPC 299/7; 209/576

(57) ABSTRACT

A method of mining is disclosed. The method includes mining material in a mine in accordance with a mine plan designed to maximise the financial performance of the mining operation at the mine. The mine plan is based on mining to at least produce: (i) recovery grade ore that is valuable and suitable for recovery processing and there is no net economic benefit in sorting the ore prior to recovery processing the ore; or (ii) waste material that is waste and there is no net economic benefit in sorting the material; or (iii) economically sortable ore wherein there is a net positive economic benefit in sorting the ore prior to recovery processing the ore

### TECHNICAL FIELD

The present invention relates to using a sorter in a method of mining material. In particular, although not exclusively, the invention relates to using a dry sorter in a method of mining. More particularly, the invention relates to selectively supplying mined material to a dry sorter to optimize the economic benefit provided by the dry sorter in a mining method.

### BACKGROUND ART

The Kennecott Utah Copper website describes the mining operation at the Bingham Canyon Mine in the following terms:

“The open pit mining methods invented at the turn of the century are still used today. The equipment, however, has grown in size and complexity with advances in technology. Today, the monstrous haulage trucks can carry 240 to 320 tons per load. The Mine's largest electric shovels have 56-cubic yard dippers that can scoop up to 85 tons of material in a single pass. Computer models help with Mining planning and sophisticated communications systems monitor all truck and shovel operations. Information collected by geologists is used by mining engineers to develop a complex mining plan on a daily, weekly, monthly, yearly and multi-year basis. The plan divides the mine into ore and waste zones. Ore is material that can be mined and processed at a profit. Waste, or overburden, is material that is not economic to process, but must be removed to expose the ore. Economics, therefore, determine what is ore and what is waste.”

It is evident from the above web site extract that the mined ore from the Bingham Canyon Mine is separated into an “ore” stream on the-basis that it is “material that can be mined and processed at a profit” and a “waste” stream on the basis that it is material that is “not economic to process”. The terms “ore” stream and “waste” stream are herein understood to have these meanings. The ore stream is processed in a downstream recovery plant to recover copper from the ore.

A key issue for mines, including Bingham Canyon Mine, is to operate economically with low grades and high capital and operating costs.

The above references to the background art and later references to the background art (particularly the description of FIG. 1) do not constitute an admission that the art forms a part of the common general knowledge of a person of ordinary skill in the art. The above references are also not intended to limit the application of the apparatus and method as disclosed herein.

### SUMMARY OF THE DISCLOSURE

The present invention is concerned with integrating a sorter, for example a dry sorter, into a method of mining material and downstream processing of mined material to recover valuable material from the mined material in the most cost beneficial way.

The present invention also extends to integration of a sorting method into a method of processing material that has been mined and is in stockpiles. In this context, references to “mined material” include mined material in stockpiles.

Introducing a sorter into a mining method or a processing method for stockpiled material requires due consideration of mine process streams to leverage the sorter to provide optimal economic advantage, i.e. improved financial performance, to be provided by the sorter to the mining method.

The applicant has realised that it is possible to improve the financial performance of a mining operation if, in addition to identifying material to be mined as an “ore ” stream or a “waste ” stream, a mine plan also:

(a) takes into account the extent to which there is mined material that is suitable for sorting to produce an “upgraded” stream of mined material that can be processed on an economic basis, and

(b) controls a mining operation to produce an “ore ” stream, a “waste ” stream, and a “sortable” stream of mined material and produces an “upgraded” stream from the sorted feed material.

The applicant has realised that any assessment of which material should be sorted by the sorter should take into account the economic benefit of sorting ore as opposed to not sorting the ore, with the economic benefit being determined by determining the “net value of sorting” (also referred to herein as “net economic benefit in sorting”) a volume of material. The term “net value of sorting” is understood to mean the “net benefits of sorting” minus the “net benefits without sorting”, where the net benefits take into account revenue and costs. Basically, sorting is economically viable only in situations where the “net value of sorting” is positive.

In broad terms, the present invention provides a method of mining that includes mining material in a mine in accordance with a mine plan designed to maximise the financial performance of a mining operation at the mine, with the mine plan being based on mining to at least produce:

i) recovery grade ore that is valuable and suitable for recovery processing and there is no net value of sorting, i.e. no net economic benefit in sorting, the ore prior to recovery processing the ore; or

ii) waste material that is waste and there is no net value of sorting, i.e. no net economic benefit in sorting, the ore; or

iii) economically sortable ore wherein there is a net value of sorting, i.e. a net economic benefit in sorting, the ore prior to recovery processing the ore.

The present invention also provides a method of mining that includes:

(a) preparing a mine plan with consideration of the cost of sorting material with a sorter and including identifying material in a mine as:
i) recovery grade ore that is valuable and suitable for recovery processing and there is no net value of sorting, i.e. no net economic benefit in sorting, the ore prior to recovery processing the ore; or
ii) waste material that is waste and there is no net value of sorting, i.e. no net economic benefit in sorting, the ore; or
iii) economically sortable ore wherein there is a net value of sorting, i.e. a net economic benefit in sorting, the ore prior to recovery processing the ore;

(b) mining the material to produce a recovery grade ore stream, a waste stream of waste material, and a sortable ore stream of economically sortable ore in accordance with the mine plan; and

(c) sorting ore fragments in the sortable ore stream by differentiating between ore fragments which are of relatively higher grade and relatively lower grade to produce an upgraded stream of relatively higher grade ore fragments suitable for recovery processing.

The sorting step may be a dry sorting step.

The term “dry sorting” is understood herein to mean any sorting process that does not require added moisture for the purpose of effecting separation and produces an “upgraded” stream and a “reject” stream. The term “upgraded” stream means higher economic value. Typically, higher grade equates to higher economic value. However, the term “upgraded” is not limited to higher grade.

The step of identifying the material in the mine as recovery grade ore or waste material or sortable ore may include taking samples of material and analysing the material prior to mining the material. For example, the method may include taking and then analysing core samples prior to mining the material.

The step of identifying the material in the mine as recovery grade ore or waste material or sortable ore may include taking samples of material and analysing the material after mining the material. For example, in a situation where a mine operates in a drill and blast mode, the method may include taking and analysing samples of material after material has been blasted and has slumped into the mine pit.

Identifying the material in the mine as recovery grade ore or waste material or sortable ore may include consideration of the grade of economic elements in the material.

Identifying the material in the mine as recovery grade ore or waste material or sortable ore includes consideration of the average grade of economic elements in the material.

Material that is recovery grade ore may be material having more than a predetermined portion of the material being above a predetermined grade of economic elements. In any given situation the value of the “predetermined portion” and the value of the “predetermined grade” will depend on a range of factors including mining costs and economic value of valuable material in a mine.

Material that is waste material may be material having more than a predetermined portion of the material in each volume being below a predetermined grade of economic elements.

Material that is recovery grade ore may be material having more than a predetermined portion of the material in a given volume being above a predetermined grade of economic elements and wherein material that is waste material is material having more than a predetermined portion of the material in a given volume being below the predetermined grade of economic elements.

The mine plan may be a geometallurgical block model.

The blocks may be any suitable geometric shape and size.

Step (b) may include mining the material in the mine and separating the mined material into the recovery grade ore stream, the waste material stream and the sortable ore stream.

Step (b) may include mining the material in the mine and separating the mined material into the recovery grade ore stream and the waste material stream and separating the sortable ore stream from the waste stream.

The method may include crushing the sortable ore stream to a required particle size distribution before sorting the stream in the sorter.

The sorter may be a bulk sorter or a particle sorter or a combination of a bulk sorter and a particle sorter.

The sorter may use any suitable technique to determine the basis for sorting material being processed in the sorter.

One suitable technique is based on the use of electromagnetic radiation, such as microwave radiation or radio frequency radiation. More specifically, step (c) of sorting ore may include:

(a) exposing ore fragments to electromagnetic radiation,

(b) detecting differences in temperature between fragments after the ore fragments have been exposed to electromagnetic radiation; and

(c) physically separating the ore fragments into at least the higher grade stream and one other stream based on the detected temperature differences between the ore fragments.

The technique may be based on the detection of localised hot spots of a material, for example on the surface of rocks or rock fragments of the material. The technique may not require the detection of an increase of average temperature of entire rocks or rock fragments of a material by say 2-3° C.

The above electromagnetic radiation based technique is described, by way of example in the following International publications and the disclosure in these International publications is incorporated herein by cross-reference: WO 2007/051225, WO 2008/017120, and WO 03/102250.

Another suitable technique for the sorter is dual energy x-ray analysis. International application PCT/AU2009/001179 (International publication WO 2010/025528) in the name of Technological Resources Pty Limited describes a method and an apparatus for dual energy x-ray analysis of a mined material. The term “dual energy x-ray analysis” is understood herein to mean analysis that is based on processing data of detected transmitted x-rays through the full thickness of each particle obtained at different photon energies. Such processing makes it possible to minimise the effects of non-compositional factors on the detected data so that the data provides clearer information on the composition, type, or form of the material. The disclosure in the specification of the International application is incorporated herein by cross-reference.

Another suitable technique is a size separation step, for example using a suitable screen, to separate the material in the sortable ore stream. This technique may be useful in situations where there are higher concentrations of valuable material in particular particle size distributions of a mined material. For example, there may be situations in which fines tend to have higher concentrations of valuable material than larger particles of mined material. Hence, the sortable stream could be screened to separate the fines from larger particles. The fines would become an upgraded stream. Depending on the characteristics of the sortable stream, the larger particles from the screen could then be further sorted, for example by the above-described electromagnetic radiation based technique or dual energy x-ray analysis technique, to produce a further upgraded stream and a reject stream. The two upgraded streams could be combined and transferred to a downstream processing operation.

Other techniques include, by way of example, x-ray fluorescence, radiometric, optical, and photometric techniques.

The material may be a copper-containing ore.

The recovery processing may be a concentrator for producing a copper concentrate.

The present invention also provides optimized use of a sorter in a mining method, wherein:

(a) economically sortable ore which has a net positive economic benefit in sorting the ore prior to recovery processing is sorted in the sorter by differentiating between ore fragments which are relatively higher grade and relatively lower grade to produce an upgraded stream of relatively higher grade ore fragments that is sent for recovery processing;

(b) recovery grade ore suitable for recovery processing without there being any net economic benefit in sorting the ore prior to recovery processing is sent to recovery processing without sorting; and

(c) waste material that is waste without there being any net economic benefit in sorting the material is sent to a waste dump or waste stockpile.

The present invention also provides a mining operation that includes;

(a) a mine,

(b) equipment for mining material and dividing the mined material into (i) recovery grade ore that is valuable and suitable for recovery processing without there being any net economic benefit in upgrading the grade of the ore by sorting prior to recovery processing or (ii) waste material that is waste and there is no net economic benefit in upgrading the waste material by sorting or (iii) economically sortable ore wherein there is a net positive economic benefit in, i.e. positive net value of, sorting the ore to improve the grade of the ore prior to recovery processing,

(c) a sorter for sorting the sortable ore stream and producing an upgraded stream and a rejects stream,

(d) equipment for transporting the recovery grade ore and the upgraded stream to a downstream processing operation at the mine or a location remote from the mine, and

(e) a mine control system for controlling the mining operation in accordance with a mine plan designed to maximise the financial performance of the mining operation at the mine, with the mine plan being based on mining to at least produce the recovery grade ore stream, the waste stream, and the sortable stream of mined material.

The mine may be an open-cut mine or an underground mine.

The mine may be a copper mine.

The downstream processing operation may be a copper concentrator.

The mining operation may include a plurality of mines.

The present invention also provides a method for recovering valuable material, such as valuable metals, from material that has been mined in accordance with the mining method described above, the method including processing the upgraded stream of material from the sorting step (c) and recovering valuable material from the upgraded material.

### BRIEF DESCRIPTION OF THE DRAWINGS

Notwithstanding any other forms which may fall within the scope of the apparatus and method as set forth in the Summary, specific embodiments will now be described, by way of example only, with reference to the accompanying drawings in which:

FIG. 1 is a schematic diagram that illustrates a known mining method;

FIG. 2a is a schematic vertical cross-section through a section of a mine that illustrates a simple mine model depicting a volume of waste material and a volume of ore for mineral recovery processing,

FIG. 2b is a top plan view of Bingham Canyon Mine that illustrates a more complex mine model in the form of a block model,

FIG. 3 is a schematic diagram that illustrates one embodiment of a mining method in accordance with the invention;

FIG. 4 is a graph of copper concentration (in wt. %) in a number of blocks of copper-containing ore versus the percentile of the mass of each block,

FIG. 5a is a diagram that illustrates a sorting and downstream processing option for block A in FIG. 4,

FIG. 5b is a is a diagram that illustrates a sorting and downstream processing option for block B in FIG. 4,

FIG. 5c is a is a diagram that illustrates a sorting and downstream processing option for block C in FIG. 4,

FIG. 6 is a graph of net value of sorting blocks of copper-containing ores versus the copper equivalent grade of the ores,

FIG. 7 is a diagram that illustrates sorting and downstream processing options for blocks within specific copper equivalent grade ranges in FIG. 7,

FIG. 8 is a schematic diagram that illustrates another embodiment of a mining method in accordance with the present invention, with particular focus on the use of a dry sorter in the mining method, and

FIG. 9 is a perspective view of one embodiment of a dry sorter in accordance with the present invention.

### DESCRIPTION OF EMBODIMENTS

The embodiments of the invention shown in the Figures are described in the context of a method of recovering a valuable metal in the form of copper from low grade copper-containing ores in which the copper is present in copper-containing minerals such as chalcopyrite and the ores also contain non-valuable gangue.

It is noted that the invention is not confined to copper-containing ore and extends to other mined materials containing valuable material, such as economic elements. The invention extends generally to mined material that is a metalliferous material or a non-metalliferous material. In addition to copper-containing ores, iron-containing and nickel-containing ores are examples of metalliferous materials. Coal is an example of a non-metalliferous material.

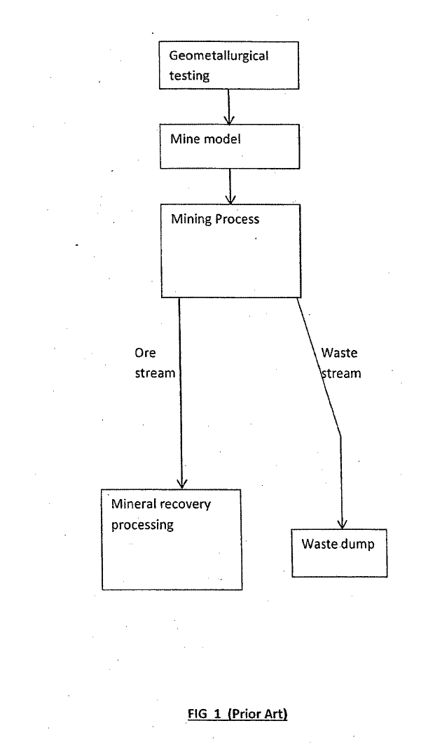

FIG. 1 is a flow diagram showing the general steps in a prior art mining method.

With reference to FIG. 1, a first step in the known method is to develop a mine model for the mine. A mine model is developed from geometallurgical testing of the material of the mine. It is possible to calculate for any mine a cut-off grade of a mined material below which it is not economic to mine and subsequently process the mined material to recover valuable material in the material. The mine model identifies ore that is considered as having value to process to recover valuable elements and waste material that is not processed.

The material in the mine is subsequently mined, for example by a conventional drill and blast method (or any other suitable mining technology) in accordance with a mine plan based on the mine model and other factors. The mined material in the ore is transferred by mining equipment such as excavators, conveyors etc to a primary crusher and is crushed to a particle size typically of 10-25 cm (0.5 to 3 inch).

The crushed ore is transferred to a mineral recovery processing facility to extract the valuable elements in the ore. The ore may include low grade ore that is stockpiled for future processing and high grade ore that is conveyed directly to the mineral recovery processing facility. The waste is mined and sent as a waste stream to a waste dump (or a waste stockpile).

The further mineral recovery processing of ore ranges from simple dry processing including crushing and screening to a standard size range through to recovery processes that beneficiate or upgrade the ore. The recovery processes may be wet or dry. The recovery processes may include leaching, including heap leaching, and flotation to produce a concentrate and smelting the concentrate.

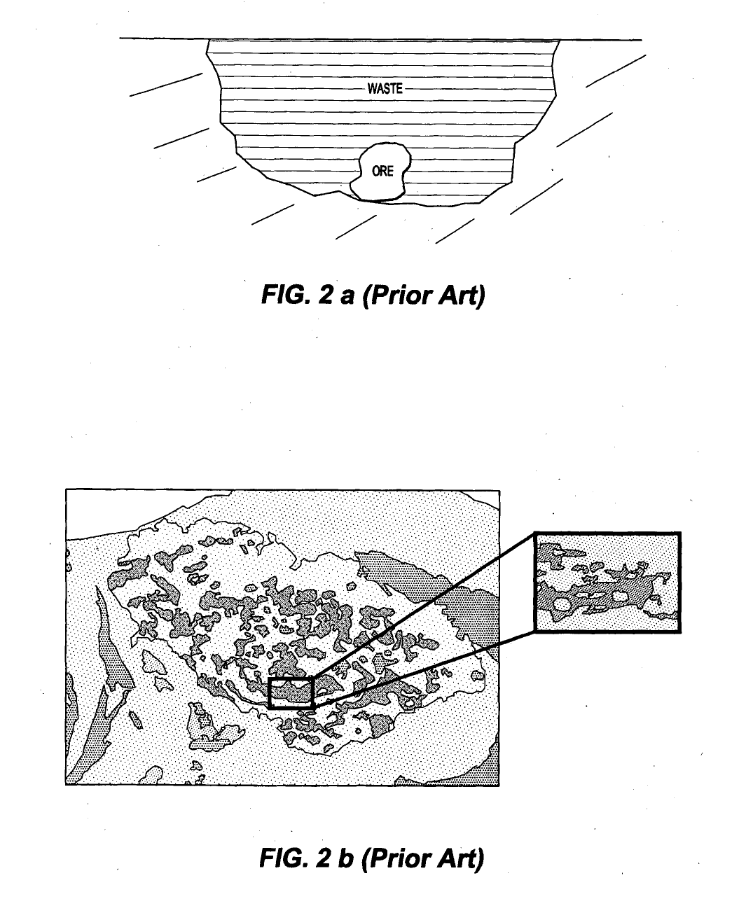

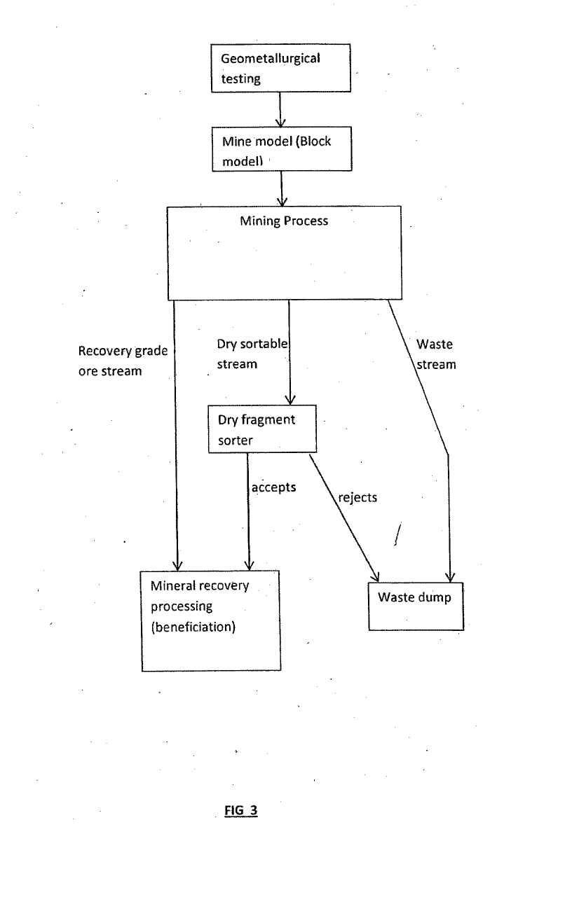

A simple known mine model for a small section of a mine is shown in FIG. 2(a). This mine model identifies a volume of waste material and a volume of ore for mineral recovery processing.

FIG. 2(b) show a more complex mine model for a whole mine. This mine model is a block model wherein the mine is modelled in volumes of material in the form of blocks. Each block is assigned attributes as determined by, for example, geometallurgical testing or financial modelling. In one example the shades of the blocks in FIG. 2(b) are indicative of different grades of copper and more specifically darker shades indicate blocks having higher grades of copper. It is known to mine metalliferous ore in large blocks, i.e. large predetermined volumes, of the ore from benches. Typically, although not always, the blocks of ore are substantial, for example 40 m long by 20 m deep by 10 m high and contain 8000 tonnes of ore in the case of iron ore 20 m long by 20 m deep by 20 m high for copper-containing ores. Typically, a section of a bench is assayed by chemically analysing samples of ore taken from a series of drilled holes in the section to determine whether the block will be processed via the ore stream or waste stream. The cut-offs between being in the ores stream or the waste stream is dependent on a range of factors and may vary from mine to mine and in different sections of mines. When the analysis is completed, a block model of the section is, prepared. The plan locates the drilled samples on a plan map of the section. Regions of (a) high grade ore, (b) low grade ore, or (c) waste material are determined by sample analysis (such as chemical assay and/or mineral/material type abundances) and are marked on the plan, with marked boundaries separating different regions. The boundaries are also selected having regard to other factors, such as geological factors. The regions define blocks to be subsequently mined. Each block of ore is blasted using explosives and is picked up from a mine pit and transported from the mine pit. The ore is processed inside and outside the mine pit depending on the grade determination for each block. For example, waste ore is used as mine fill, low grade ore is stockpiled or used to blend with high grade ore, and high grade ore is processed further as required to form a marketable product.

The following description refers to “blocks” as an example of a volume of material. In this context, it is noted that the term “block” is not confined to a particular geometric shape or a particular volume.

FIG. 3, illustrates one embodiment of a mining method in accordance with the invention. The mining method includes a number of the same steps that are in the known mining method shown in FIG. 1. These steps include geometallurgical testing and the development of a mine model, mining material in a mine in accordance with the mine model and having regard to other factors and producing process streams in the form of an ore stream (described as a “recovery grade ore stream” in the Figure) and a waste stream, and processing the ore stream in a mineral recovery processing plant to extract the valuable elements in the ore and transferring the waste stream to a waste dump (or a waste stockpile). In the case of a copper-containing ore, the recovery processing plant may include a copper concentrator.

FIG. 3 illustrates that the mining method also includes producing a process stream in the form of a dry sortable stream. The basis for selecting mined material for the dry sortable stream is discussed below. FIG. 3 illustrates that the mining method also includes sorting the dry sortable stream in a dry sorter to produce an “accepts” stream and a “rejects” stream and processing the accepts stream in the mineral recovery processing facility to extract valuable plant.

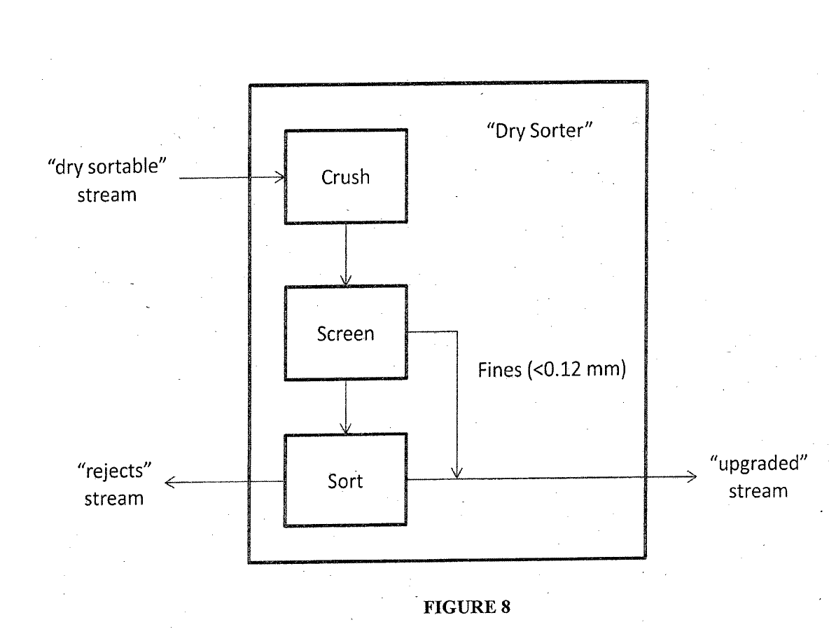

In use, the dry sorter used in the FIG. 3 method sorts ore fragments into the accepts stream and the rejects stream based on the grade of the ore fragments. The accepts stream is also referred to as the “upgraded” ore fragment, stream. That is to say that in relation to this embodiment the average grade of ore fragments in the accepts stream is higher (the dry sortable stream is “upgraded”) than the average grade dry of ore fragments in the dry sortable stream received by the dry sorter. There is a cost associated with operating the dry sorter and transporting ore fragments to and from the ore sorter. A specific embodiment of a dry ore sorter is described with reference to FIG. 8.

The applicant has realised that it is not necessarily always economically beneficial to dry sort the ore fragments of a particular block and that, therefore, it is important to have a clear basis for directing ore for sorting in the dry sorter. This realisation is not confined to dry sorting and extends to sorting generally. More particularly, and in general terms, the applicant has realised that any assessment of which blocks should be sorted should take into account the economic benefit of sorting the material as opposed to not sorting the material. As is described above, this can be expressed as the “net value of sorting” the blocks, where this term is understood to mean the “net benefits of sorting” minus the “net benefits without sorting”, and these terms are understood to mean, as follows:

(a) “net benefits of sorting” means revenue minus (mining and sorting and downstream processing, i.e. recovery) costs; and

(b) “net benefits without sorting” means revenue minus (mining and downstream processing, i.e. recovery) costs.

Basically, the term “net value of sorting” means the difference between (a) revenue minus costs when mined material is sorted and (b) revenue minus costs when mined material is not sorted. In other words, the term “net value of sorting” means the economic benefit, specifically the additional cash flow after all costs are taken into account, obtained by sorting at least some of the mined material compared to not sorting the material.

In the context of considering “net value of sorting”, the applicant has realised that if the portion of mined material that is rejected by a method of sorting mined material is set arbitrarily at a fixed value and does not take into account economic factors, less than optimum economic value may be obtained. More particularly, the applicant has realised that optimum economic value is more likely to be obtained when blocks of material processed in a sorting method are selected based on the portion of the material in each block that is below an economic cut-off grade. In any given mine, the portion will depend on the mining and sorting and downstream processing, i.e. recovery, costs relevant to that mine and the economic value of the valuable material in the mine.

Blocks are not worth sorting where the blocks have an homogeneous distribution of copper through the blocks.

Where blocks are not homogeneous, at the extreme, blocks are not worth sorting where all of the material in the blocks is below an economic cut-off grade. The sorter will simply sort all the fragments into rejects, providing no sorting benefit, whilst incurring the cost associated with operating the sorter. Similarly, where blocks, are not homogeneous, blocks are not worth sorting where all the material in the blocks is above an economic cut-off grade. The sorter will simply sort all the fragments into accepts, providing no sorting benefit, whilst incurring the cost associated with operating the sorter.

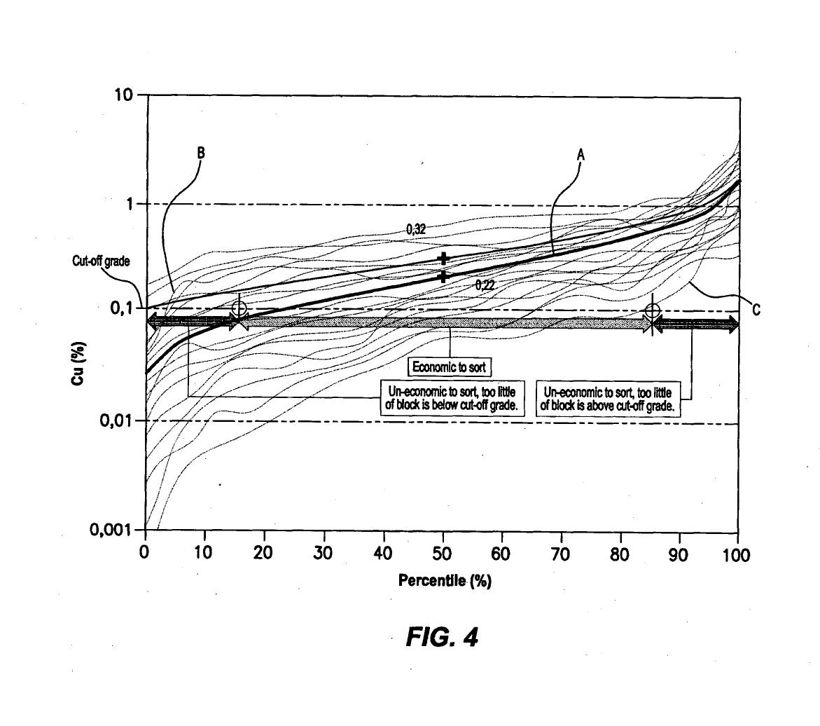

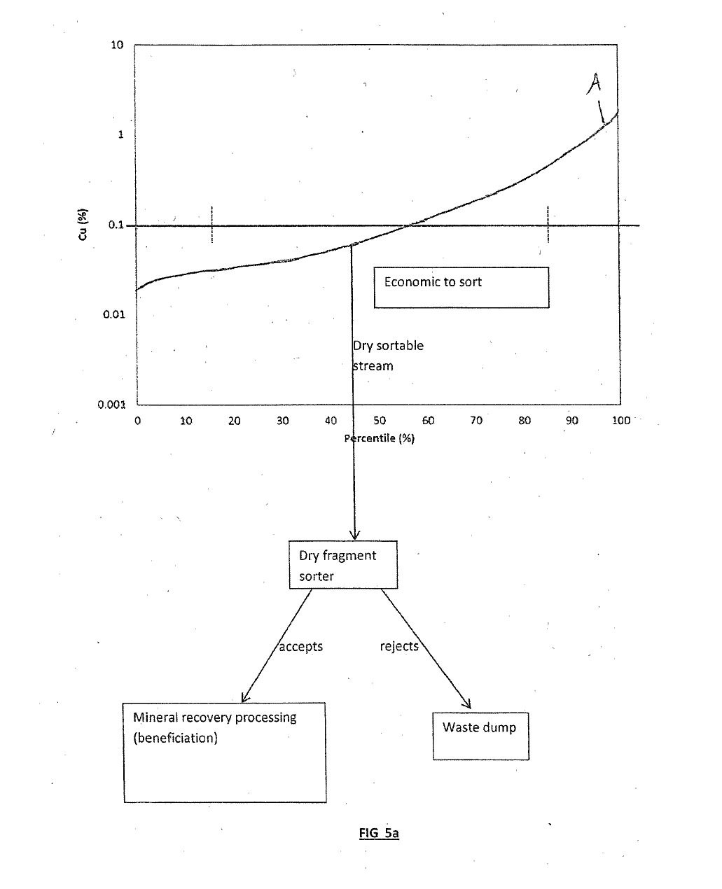

The economic benefit from the use of the sorter can be optimized by sorting the lowest grade ore blocks and highest grade waste blocks. This is illustrated by reference to FIGS. 4 to 8.

FIG. 4 includes a number of separate plots of copper concentration (in wt. %) versus the percentile of the mass of each block for different blocks of ore from a mine. FIG. 4 is one example of identifying blocks of mined material that have a net value of sorting. The cut-off grade is less than 0.1% copper as indicated by the horizontal “cut-off” grade line. As indicated above, this is not an absolute value for all mines and will vary from mine to mine. The value may also change during the life of a mine. The grade distribution for a number of blocks is indicated by the respective grade distribution lines in the graph.

In the embodiment of the invention shown in the FIG. 4, material to be mined is analysed to assess whether there is economic benefit in sorting the blocks of material after being mined. The assessment is made by taking sufficient core samples of each block of material to be mined and analysing the samples to determine the copper grades of the samples and then determining the portion of the material in each block that is below a predetermined economic cut-off grade for the mine. It is noted that the analysis of material may be made after material has been mined. For example, in the case of mines that operate in a drill and blast mode, the samples may be taken and analysed after material has been blasted and has slumped into a mine pit. In any given situation, the total number of samples required will vary with the amount of material that has been blasted and other factors, such as the variability of grade in that particular section of the mine. There may be situations where samples are taken and analysed before mining and samples are taken and analysed after mining.

In effect, the purpose of the analysis is to determine whether the blocks are in or outside the 15% to 85% percentile band, based on mass of the blocks, that is described as being “economic to sort” in the Figure. In the context of the mine samples analysed for FIG. 4, there is a positive net value in dry sorting blocks where the grade distribution line crosses the cut-off grade line in the band between the 15% percentile and 85% percentile as indicated. That is to say that there is a positive net value in dry sorting a block where more than 15% of the block is below the cut-off grade but not more than 85% of the block is below the cut-off grade. Blocks falling within this definition have grade distribution lines crossing the cut-off grade between the 15th percentile and the 85th percentile as indicated by the “economic to sort” label. The grade distribution line for a block labelled “A” is one such instance where it is considered that there will be positive net value in sorting the fragments from the block.

The lower end of the band indicates that blocks that contain less than 15% of the total mass of the blocks with a copper concentration of less than 0.1 wt. % are not economic to sort and thereafter process downstream compared to directly processing the block without the sorting step. This is to say that so much of the block is above the cut-off grade that it is more economic to simply process all of a block rather than to sort the block to separate fragments. If the fragments of the block were to be sorted, so little of the fragments would be rejected that it makes economic sense to avoid the cost of sorting and rather have the fragments of the block directly transferred for downstream processing. The grade distribution line for a block labelled “B” is one such instance where it is considered that there will not be any positive net value in sorting the fragments from the block, but rather have the block sent directly to mineral recovery processing.

The upper end of the band indicates that blocks wherein between 85% and 100% percentile (i.e. only 15% or less of the block) contain more than 0.1 wt. % are not economic to sort and thereafter process downstream compared to directly processing the block without the sorting step. This is to say that more than 85% of the block is below the cut-off grade. So little of the block is thus above the cut-off grade that it is more economic to send the ore fragments to waste. If the fragments of the block were sorted, so little of the fragments would be accepted that it makes economic sense to avoid the cost of sorting. The grade distribution line for a block labelled “C” is one such instance where it is considered that there will not be any positive net value in sorting the fragments from the block and it is preferable to have the block sent directly to waste.

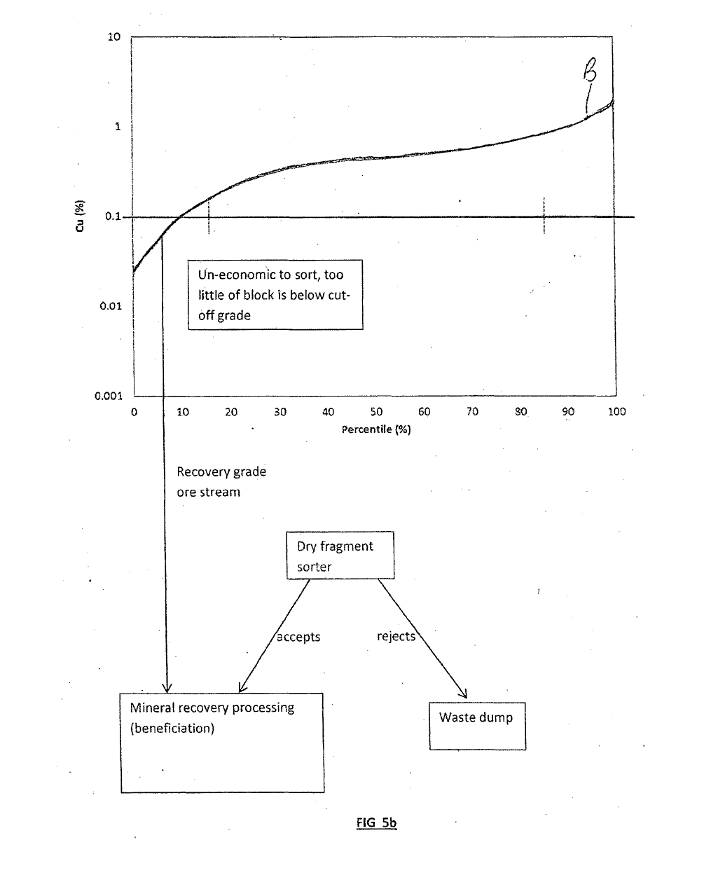

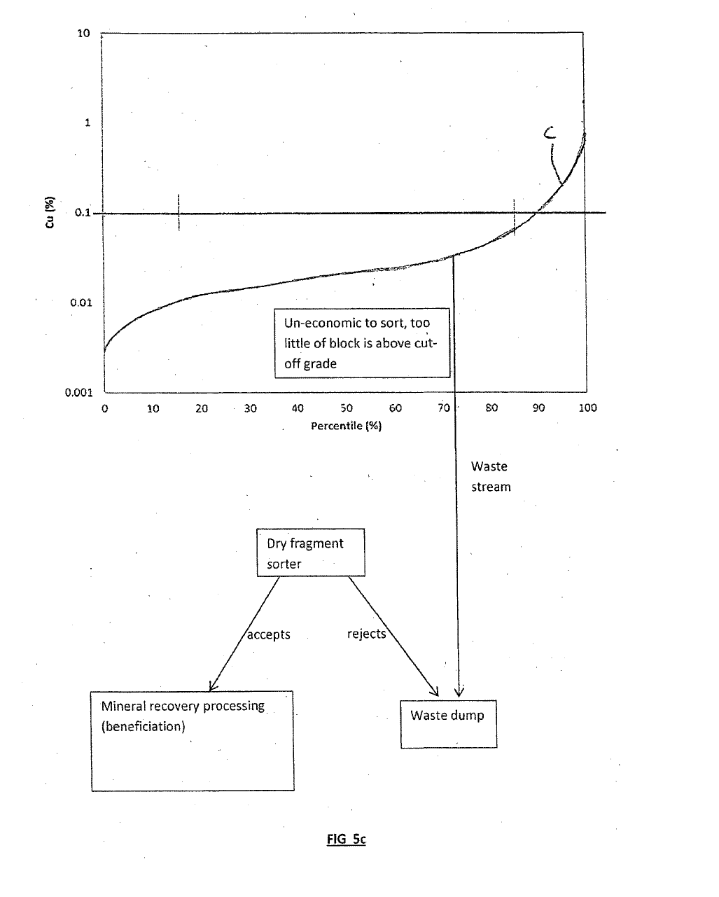

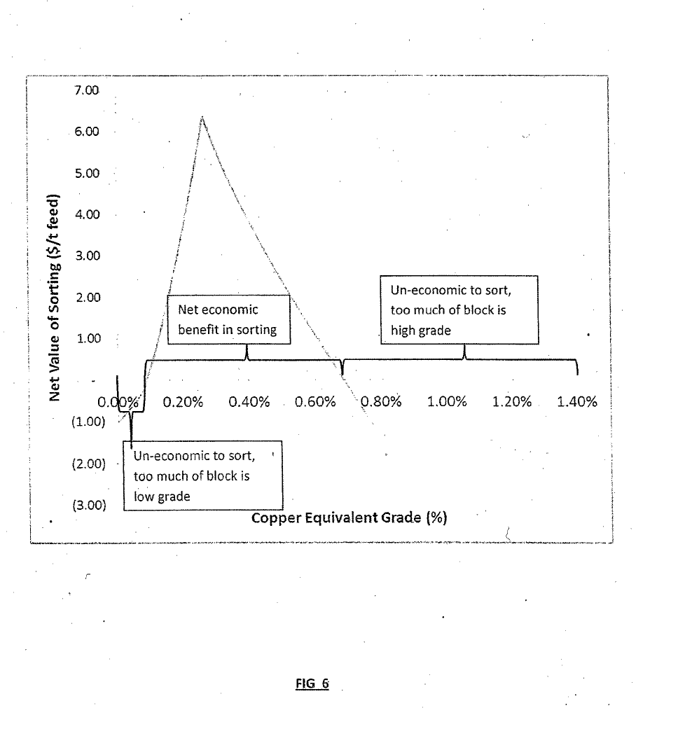

FIGS. 5a, 5b and 5c are diagrams showing the blocks A, B and C, respectively, having their grade distribution lines cross the cut-off grade line in the bands of the graph in FIG. 4 allocated to the logically determined stream, being either the recovery grade ore stream, dry sortable ore stream, or waste material stream.

For each block of material in the mine, it is likely that the portion of the material in the block that is below the cut-off grade will be different. As a general proposition, although it is not always the case, the higher the average grade of a block, the smaller the portion of the material in the block that is below an economic cut-off grade. The average grade of a block is indicated at the 50 percentile. The mass average grade for block “A” in FIG. 4 is indicated as being 0.22 wt %. It is evident from FIG. 4 that there is considerable variation in the copper concentrations in the blocks and the distribution of copper within the blocks. An important point that emerges from FIG. 4 is that there can be two blocks that have the same mass average copper grade and two significantly different distributions of copper with the blocks, with these two different copper distributions being quite different in terms of suitability for dry sorting. The different distributions of copper within the blocks are due to other factors, such as the mineralogy of the material in the blocks.

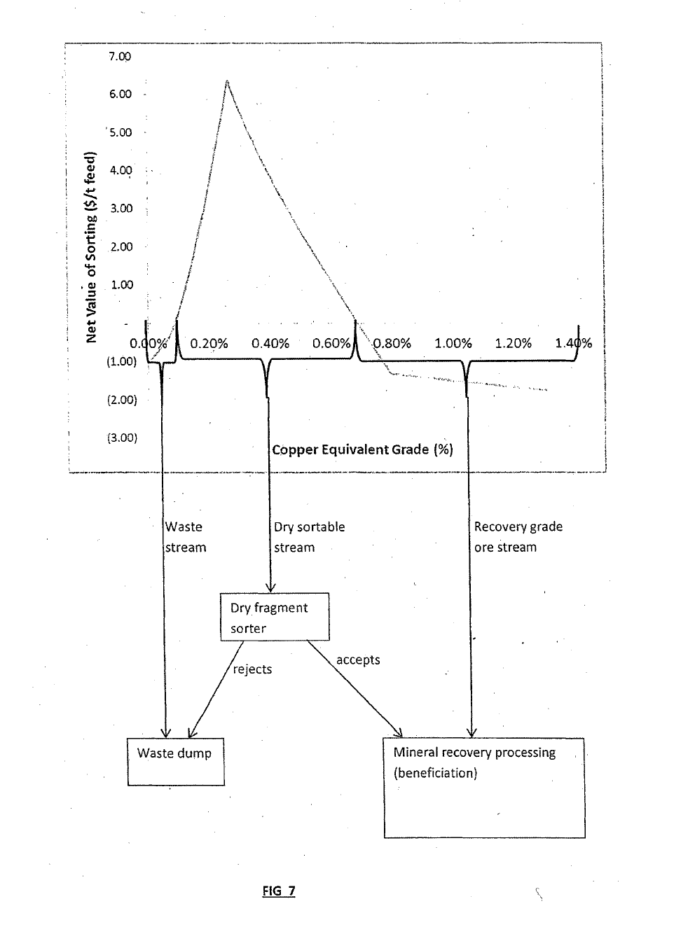

Nevertheless, an alternative embodiment to the method described with reference to FIG. 4 includes the allocation of a block of mined material in one of the recovery grade ore stream, dry sortable ore stream, or waste material stream on the basis of the mass average grade for the block as is discussed herein below with reference to FIG. 6.

FIG. 6 is a graph of net value of sorting blocks of copper-containing ores versus the copper equivalent grade of the ores (where “equivalent” includes the value of other valuable minerals Mo, Au, Ag). The graph indicates that there is a positive net value of sorting blocks, as described above, that have a mass average copper equivalent grade in a range of 0.1 to 0.7 wt. %. for the blocks evaluated and having regard to the mining conditions in the particular mine from which the blocks were sourced. The graph shows that the net value of sorting increased quickly from a grade of 0.1 wt. % to a maximum at a grade of 0.3 wt. % and then decreased quickly as the copper grade decreased to 0.7 wt. %. It is noted that at average copper equivalent grades above 0.7 wt. %, it is more economic to simply process all of a block rather than to sort the block to separate fragments below a cut-off grade, for example of 0.1 wt. %, and then to recover copper from the selected fragments.

FIG. 7 is a diagram showing the blocks having mass average equivalent grades in the bands of the graph in FIG. 6 allocated to the logically determined stream, being either the recovery grade stream, dry sortable stream, or waste stream.

FIG. 8 illustrates in conceptual terms another, although not the only other possible, embodiment of a mining method in accordance with the invention. FIG. 8 focuses on the dry sorting step of the mining method. This embodiment is applicable in situations where there is material in the mine that has (a) fines that have relatively high concentrations of valuable material such as copper and (b) coarse material that is suitable for sorting by the above-described electromagnetic radiation based technique. The material having characteristics (a) and (b) becomes a dry sortable ore stream. The dry sorter shown in the Figure processes the dry sortable stream of mined material by initially crushing the material to a required particle size distribution and then screening the crushed material to form a fines stream (less than 0.12 mm in this instance) and a coarse stream. The fines stream is an upgraded stream. The coarse stream is then further dry sorted, for example by the above-described electromagnetic radiation based technique (or by a dual energy x-ray analysis technique or any other suitable technique) to produce a further upgraded stream and a reject stream. The two upgraded streams are combined and transferred to a downstream processing operation.

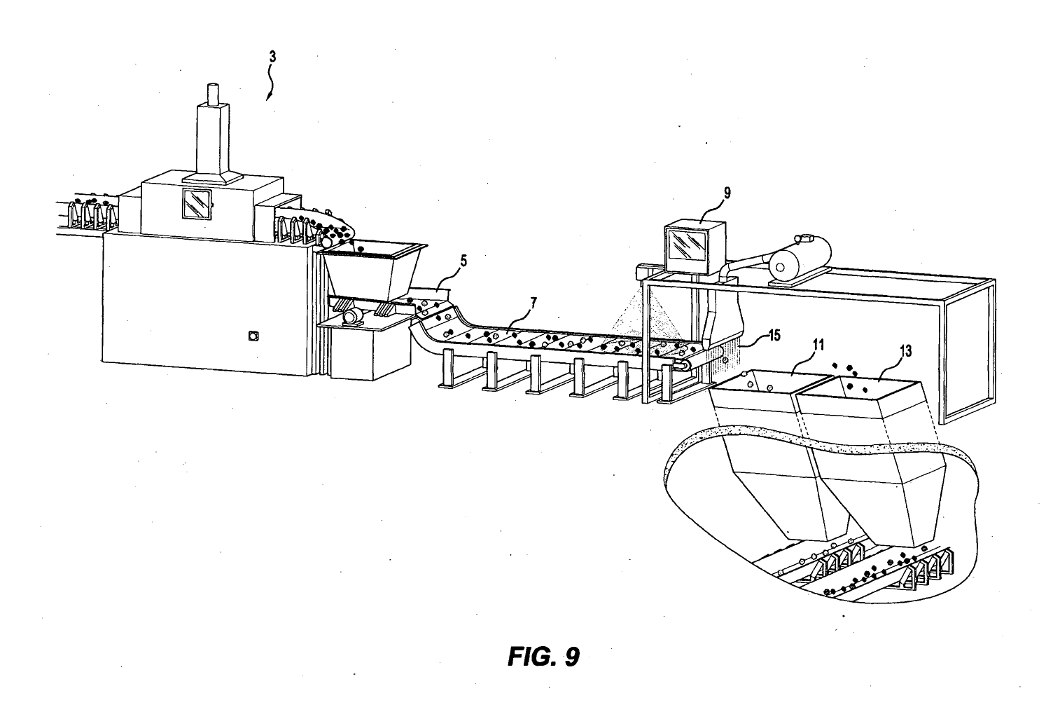

FIG. 9 shows one example of a dry sorter being developed by the applicant that is suitable for use in the dry sorting steps in the mining methods described in relation to FIGS. 3 and 8. The dry sorter includes a microwave radiation station 3 that includes an applicator for exposing fragments of mined material to microwave radiation, a source of microwave radiation, and one or more than one waveguide for transferring microwave radiation from the source to the applicator. A stream of fragments is transported through the applicator on a suitable conveyor belt assembly 5. As-viewed in FIG. 8, the conveyor belt 5 transports the material from the left to the right of the Figure. The conveyor belt assembly 5 includes several separate belts along the length of the dry sorter. The dry sorter also includes an infrared detection unit 9 for detecting the thermal response of the fragments to exposure to microwave radiation and a control unit (not shown) that processes data from the infrared detection unit 9 and determines whether fragments should be sorted into an accepts category or a rejects category. The dry sorter also includes an air jet-based sorter 15 positioned downstream of the infrared detection unit 9 and operable across the, entire width of the downstream end of the conveyor belt assembly 5 to project fragments selectively into an accepts bin 11 or a rejects bin 13.

In general terms, the method of dry sorting mined material in the dry sorter shown in FIG. 9 includes the following steps:

(a) exposing fragments of mined material to microwave radiation (or other suitable electromagnetic radiation, such as radio frequency radiation) in the microwave radiation station 3;

(b) detecting thermal properties of the fragments (or other suitable properties) using the infrared detection unit 9 after the material has been exposed to microwave radiation;

(c) assessing the differences in properties between fragments; and

(d) physically separating the ore fragments via the air jet-based sorter 15 into at least the higher grade accepts stream and the lower grade rejects stream based on the detected property differences between the ore fragments.

The properties detected for different types of dry ores sorters may include any one or more of the characteristics of composition (including grade of a valuable metal), mineralogy, hardness, porosity, structural integrity, dielectric properties, and texture of the mined material.

The dry sorter may sort the fragments in the selected blocks on the basis of whether the fragments are at or above a cut-off grade or below the cut-off grade. The cut-off grade may also be determined by other considerations, such as the distribution of copper in the block, which have a bearing on selection of operating parameters for the dry sorter.

An example of a microwave based dry sorter that may be utilized is described in pending International application PCT/AU2006/001561 entitled “Method of Determining the Presence of a Mineral within a Material” which is also incorporated herein by reference. An example of a radio frequency based dry sorter is described in pending International application PCT/AU2010/001712 entitled “Sorting Mined Material”, which is incorporated herein by reference.

The embodiments are described in the context of the use of a dry sorter that is a fragment sorter that uses electromagnetic radiation to facilitate identifying higher copper concentration fragments of material. It is noted that the invention is not confined to the use of this type of dry sorter and extends to the use of any other option for providing information on characteristics of the mined material that makes it possible to separate fragments on the basis of perceived grade of the fragments.

Many modifications may be made to the embodiment of the invention described herein without departing from the spirit and scope of the invention. The mined material includes mined material that is in stockpiles.

It is also noted that the present invention is not confined to copper-containing ores and to copper as the valuable material to be recovered. The applicant is interested particularly in copper-containing ores in which the copper is present in the ore fragments as a sulphide, such as chalcopyrite or chalcocite. However, by way of example only, the applicant is also interested in nickel-containing ores in which the nickel is present in the ore fragments as a sulphide, iron sulphide containing ores, and in uranium-containing ores.

It is also noted that the words “fragment” and “particle” as used herein have the same meaning.

In the claims which follow, and in the preceding description, except where the context requires otherwise due to express language or necessary implication, the word “comprise” and variations such as “comprises” or “comprising” are used in an inclusive sense, i.e. to specify the presence of the stated features but not to preclude the presence or addition of further features in various embodiments of the apparatus and method as disclosed herein.

1. A method of mining includes:
(a) preparing a mine plan with consideration of the cost of sorting material with a sorter and including identifying material in a mine as:
i) recovery grade ore that is valuable and suitable for recovery processing and there is no net economic benefit in sorting the ore prior to recovery processing the ore; or
ii) waste material that is waste and there is no net economic benefit in sorting the material; or
iii) economically sortable ore wherein there is a net positive economic benefit in sorting the ore prior to recovery processing the ore;
(b) mining the material to producing a recovery grade ore stream, a waste stream of waste material, and a sortable stream of economically sortable ore in accordance with the mine plan; and
(c) sorting ore fragments in the sortable stream by differentiating between ore fragments which are of relatively higher grade and relatively lower grade to produce an upgraded stream of relatively higher grade ore fragments suitable for recovery processing.

2. The method defined in claim 1, wherein the sorting step (c) includes dry sorting the ore.

3. The method defined in claim 1 including identifying the material in the mine as recovery grade ore or waste material or sortable ore includes consideration of the grade of economic elements in the material.

4. (canceled)

5. The method defined in claim 3, wherein material that is recovery grade ore is material having more than a predetermined portion of the material being above a predetermined grade of economic elements.

6. The method defined in claim 3, wherein material that is waste material is material having more than a predetermined portion of the material in each volume being below a predetermined grade of economic elements.

7. The method defined in claim 1, wherein material that is recovery grade ore is material having more than a predetermined portion of the material in a given volume being above a predetermined grade of economic elements and wherein material that is waste material is material having more than a predetermined portion of the material in a given volume being below the predetermined grade of economic elements.

8. (canceled)

9. The method defined in claim 1 wherein step (c) of sorting ore includes:
(a) exposing ore fragments to electromagnetic radiation,
(b) detecting differences in temperature between fragments after the ore fragments have been exposed to electromagnetic radiation;
(c) physically separating the ore fragments into at least the higher grade stream and one other stream based on the detected temperature differences between the ore fragments.

10. (canceled)

11. The method defined in claim 1 wherein the material is a copper-containing material.

12. (canceled)

13. A method for recovering valuable material, such as valuable metals, from material that has been mined in accordance with the method defined in claim 1, the method including processing the upgraded stream of material from the sorting step (c) and recovering valuable material from the upgraded material.

14. The method defined in claim 13 wherein the material is a copper-containing material.

15. (canceled)

16. Optimized use of a sorter in a mining method, wherein:
(a) economically sortable ore which has a net positive economic benefit in sorting the ore prior to recovery processing is sorted in the sorter by differentiating between ore fragments which are relatively higher grade and relatively lower grade to produce an upgraded stream of relatively higher grade ore fragments that is sent for recovery processing;
(b) recovery grade ore suitable for recovery processing without there being any net economic benefit in sorting the ore prior to recovery processing is sent to recovery processing without sorting; and
(c) waste material that is waste without there being any net economic benefit in sorting the material is sent to a waste dump or waste stockpile.

17. The use of the sorter defined in claim 16 includes dry sorting the ore.

18. The use of the sorter defined in claim 16 including identifying the material in the mine as either recovery grade ore or waste material or sortable ore, wherein the identification step includes consideration of the grade of economic elements in the material.

19. (canceled)

20. The use of the sorter defined in claim 18, wherein material that is recovery grade ore is material having more than a predetermined portion of the material being above a predetermined grade of economic elements.

21. The use of the sorter defined in claim 18, wherein material that is waste material is material having more than a predetermined portion of the material in each volume being below a predetermined grade of economic elements.

22. The use of the sorter defined in claim 16, wherein material that is recovery grade ore is material having more than a predetermined portion of the material in a given volume being above a predetermined grade of economic elements and wherein material that is waste material is material having more than a predetermined portion of the material in a given volume being below the predetermined grade of economic elements.

23-24. (canceled)

25. The use of the sorter defined in claim 16, wherein sorting includes:
(a) exposing ore fragments to electromagnetic radiation,
(b) detecting differences in temperature between fragments after fragments have been exposed to electromagnetic radiation;
(c) physically separating ore fragments into at least the higher grade stream and one other stream based on the detected temperature differences between ore fragments.

26. A method of mining that includes mining material in a mine in accordance with a mine plan designed to maximise the financial performance of the mining operation at the mine, with the mine plan being based on mining to at least produce:
i) recovery grade ore that is valuable and suitable for recovery processing and there is no net economic benefit in sorting the ore prior to recovery processing the ore; or
ii) waste material that is waste and there is no net economic benefit in sorting the material; or
iii) economically sortable ore wherein there is a net positive economic benefit in sorting the ore prior to recovery processing the ore.

27. The method defined in claim 26 includes dry sorting the ore.

28. The method defined in claim 26 wherein the material is a copper-containing material.

29. (canceled)
